(19) United States
(12) Patent Application Publication
(10) Pub. No.: US 2005/0243359 A1
(43) Pub. Date: Nov. 3, 2005

(54) Image data communication system, and image server and portable electronic device and methods of controlling the same

(75) Inventor: Mikio Watanabe, Kurokawa-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/115,246

(22) Filed: Apr. 27, 2005

(30) Foreign Application Priority Data
Apr. 28, 2004 (JP) 2004-132361

(51) Int. Cl. G06F 3/12; H04N 5/225

(52) U.S. Cl. 358/1.13; 348/207.2; 348/333.01; 455/566; 715/864; 358/1.15; 455/556.1

(57) ABSTRACT

A menu suited to give a command utilizing an up/down button in a digital still camera is displayed on a liquid crystal viewer in a camera. In the digital still camera that can communicate with a printer, data representing the up/down button is transmitted as the type of an input device provided in the camera to the printer. In the printer, menu contents suitable for the camera having the up/down button are found. The found menu contents are transmitted to the digital still camera from the printer. The menu is displayed on the liquid crystal viewer in the camera. On the menu, areas are arranged in line in the longitudinal direction such that a command can be given to the camera using the up/down button. The menu to which the command is easily inputted utilizing the up/down button is displayed on the liquid crystal viewer in the camera.

### BACKGROUND OF THE INVENTION

1. Field of the Invention

The present invention relates to an image data communication system, and an image server and a portable electronic device and methods of controlling the same.

2. Description of the Related Art

In a system that establishes communication between a client computer and a server computer, for example, a client server model, when the client computer is controlled, image data representing a menu is obtained from the client computer, and the client computer is controlled using the menu represented by the obtained image data (see the specification of Japanese Patent Application Laid-Open No.11-39120).

However, a device composing the communication system is not necessarily limited to one comprising a sufficient number of input devices such as a keyboard and a mouse, for example, a personal computer or the like. There is a communication device that only has such a poor input device as to move a cursor up and down or right and left.

### DISCLOSURE OF THE INVENTION

An object of the present invention is to transmit an input image suitable for an input device of a portable electronic device to the portable electronic device.

The present invention is directed to an image data communication system comprising a portable electronic device and an image server that can communicate with each other.

The portable electronic device comprises a display device that displays an input image represented by input image data transmitted from the image server, an input device that gives a command to the portable electronic device on the basis of the input image displayed on a display screen of the display device, and a type data transmission device that transmits to the image server type data representing the type of the input device.

The image server comprises a detection device that detects the input image suitable for display on the display screen of the display device in the portable electronic device on the basis of the type data transmitted from the type data transmission device in the portable electronic device, and an input image data transmission device that transmits to the portable electronic device the input image data representing the input image detected by the detection device.

According to the present invention, the portable electronic device is provided with a display device and an input device that gives a command to the portable electronic device. The type data representing the type of the input device is transmitted to the image server from the portable electronic device.

When the type data transmitted from the portable electronic device is received in the image server, the input image suitable for display on the display screen of the display device in the portable electronic device is detected on the basis of the received type data. The input image data representing the detected input image is transmitted to the portable electronic device from-the image server.

On the portable electronic device, the input image suitable for the input device provided in the portable electronic device is displayed. Even when there is provided only an input device that gives a command to move a cursor up and down or right and left, for example, the command can be given relatively simply using the input device.

There may be further provided an input image data generation device that generates the input image data representing the input image detected by the detection device. In this case, the input image data transmission device will transmit to the portable electronic device the input image data generated by the input image data generation device. Since the input image data is not previously generated but generated in response to transmission of the type data from the portable electronic device, the necessity of a memory for storing the input image data is eliminated in the image server, or the memory capacity may be small.

The image server may further comprise an input image data storage device that stores input image data representing a plurality of input images corresponding to the type of the input device in the portable electronic device, and a retrieval device that finds, out of the input image data stored in the input image data storage device, the input image data corresponding to the input image detected by the detection device. In this case, the input image data transmission device will transmit to the portable electronic device the input image data found by the retrieval device. Since the input image data is previously stored, the input image data suitable for display is quickly transmitted to the portable electronic device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the overview of an image data communication system;

FIG. 2 is a rear view of a digital still camera;

FIG. 3 is a block diagram showing the electrical configuration of the digital still camera;

FIG. 4 illustrates the appearance of a portable telephone equipped with a digital camera;

FIG. 5 is a block diagram showing the electrical configuration of the portable telephone equipped with a digital camera;

FIG. 6 is a block diagram showing the electrical configuration of a printer;

FIG. 7 illustrates menu contents stored in the printer;

FIG. 8 is a flow chart showing the procedure for communication processing between the digital still camera and the printer;

FIG. 9 illustrates the transition of menu contents displayed on the digital still camera;

FIG. 10 illustrates the transition of menu contents displayed on the portable telephone equipped with a digital camera;

FIG. 11 illustrates a table representing menu contents information;

FIGS. 12A and 12B illustrate examples of background images;

FIG. 13 is a flow chart showing the procedure for communication processing between the portable telephone equipped with a digital camera and the printer; and

FIG. 14 illustrates the transition of menu contents displayed on the portable telephone equipped with a digital camera.

### DESCRIPTION OF THE PREFERRED EMBODIEMNTS

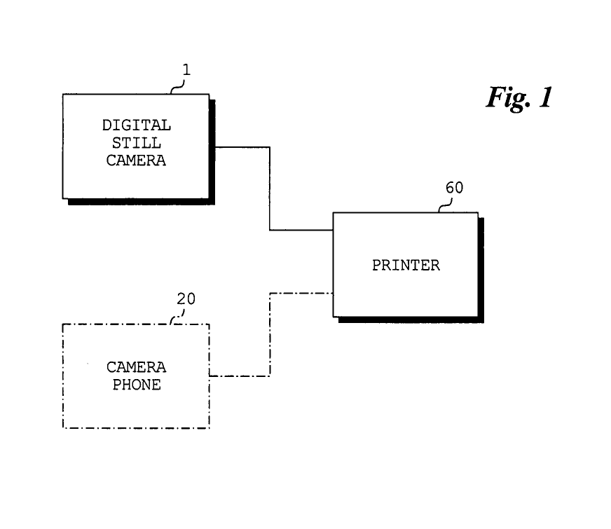

FIG. 1 illustrates an embodiment of the present invention, showing the overview of an image data communication system.

The image data communication system comprises a printer (an image server) 60, and a portable electronic device capable of establishing communication (which may be radio communication or wire communication) with the printer 60. Although a digital still camera 1 and a portable telephone equipped with a digital camera (hereinafter camera phone) 20 are illustrated in FIG. 1 as an example of a portable electronic device, it goes without saying that another device may be used.

In the present embodiment, from the digital still camera 1 or the camera phone 20, type data representing the respective types of an input device and a display device (at least the type of an input device) provided therein are transmitted to the printer 60. Input image data respectively representing input images, suitable for the input device and the display device, represented by the type data are transmitted to the digital still camera 1 or the camera phone 20 from the printer 60. An input image (a menu) represented by input image data (menu contents) is displayed on a display screen of the digital still camera 1 or the camera phone 20, and a command such as a printing command is given to the digital still camera 1 or the camera phone 20, as described later, using the input device while seeing the displayed input image, and is given to the printer 60. An image is printed in the printer 60 in response to the command. The details will be apparent from the following description.

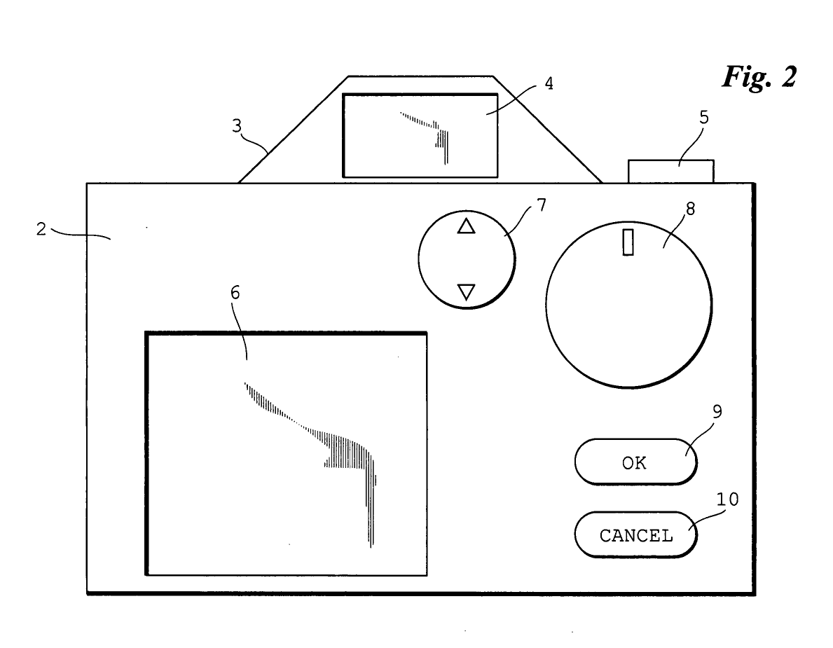

FIG. 2 is a rear view of the digital still camera 1.

The digital still camera 1 comprises a main body section 2 in a substantially rectangular parallelepiped shape and an attachment section 3 having a substantially trapezoidal shape formed on an upper surface of the main body section 2. An ocular finder 4 is formed on a rear surface of the attachment section 3. The ocular finder 4 is composed of a liquid crystal display device. A shutter release button 5 is provided on the right side of the attachment section 3 as viewed from the rear on an upper surface of the main body section 2.

A liquid crystal viewer 6 is formed on substantially the whole of a rear surface of the main body section 2. An up/down button 7 in which an up-arrow and a down-arrow are formed so as to be capable of being pressed is provided at the upper right of the liquid crystal viewer 6. On the right side of the up/down button 7, a mode setting dial 8 being rotatable and setting a mode (an image pick-up mode, a reproduction mode, etc.) is provided. Further, an OK button 9 and a cancel button 10 are provided below the mode setting dial 8.

In the digital still camera 1, the up/down button 7, the OK button 9, and the cancel button 10 are thus provided as an input device for giving a command while seeing an input image displayed on the liquid crystal viewer 6.

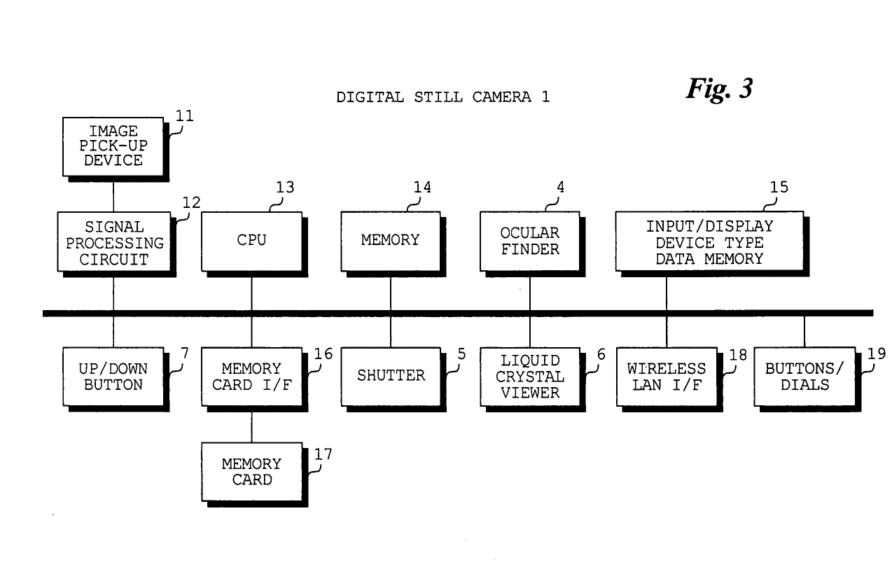

FIG. 3 is a block diagram showing the electrical configuration of the digital still camera 1.

The overall operation of the digital still camera is supervised by a CPU 13.

As described above, data representing the type of an input device and the type of a display device are transmitted to the printer 60 from the digital still camera 1. Therefore, the digital still camera 1 comprises an input/display device type data memory 15 for storing the type data.

The digital still camera 1 comprises buttons/dials 19 such as the shutter release button, the OK button, the cancel button, the mode setting dial, and a code input dial in addition to the up/down button 7, as described above. Various types of signals outputted from the buttons/dials 19 are inputted to the CPU 13.

When an image pick-up mode is set by the mode setting dial, a subject is sensed by an image pick-up device 11 such as a CCD, and a video signal representing the subject image is inputted to a signal processing circuit 12. In the signal processing circuit 12, predetermined signal processing such as white balance adjustment, analog-to-digital conversion processing or the like is performed, so that digital image data representing the subject image is outputted. The digital image data is fed to the ocular finder 4 and the liquid crystal viewer 6. The subject image is displayed on respective display screens of the ocular finder 4 and the liquid crystal viewer 6.

When the shutter release button 5 is pressed, digital image data obtained by the sensing is fed to a memory 14 and is temporarily stored therein. The digital image data is read out of the memory 14, and is fed to a memory card 17 via a memory card interface 16 and is recorded therein. It goes without saying that the image data is subjected to data compression processing, as required, and the data-compressed image data is recorded in the memory card 17.

When a reproduction mode is set, the image data recorded on the memory card 17 is read via the memory card interface 16. The read digital image data is fed to the ocular finder 4 and the liquid crystal viewer 6. An image represented by the image data recorded in the memory card 17 is displayed on the respective display screens of the ocular finder 4 and the liquid crystal viewer 6. It goes without saying that data expansion processing is performed, as required.

When a print mode is set, the type data stored in the input/display device type data memory 15 is read, and the read type data is transmitted to the printer 60 by a wireless LAN (Local Area Network) interface 18. Consequently, input image data suitable for the input device in the digital still camera 1 is transmitted to the digital still camera 1 from the printer 60. An input image suited to be given a command from the input device is displayed on the screen of the liquid crystal viewer 6 in the digital still camera 1.

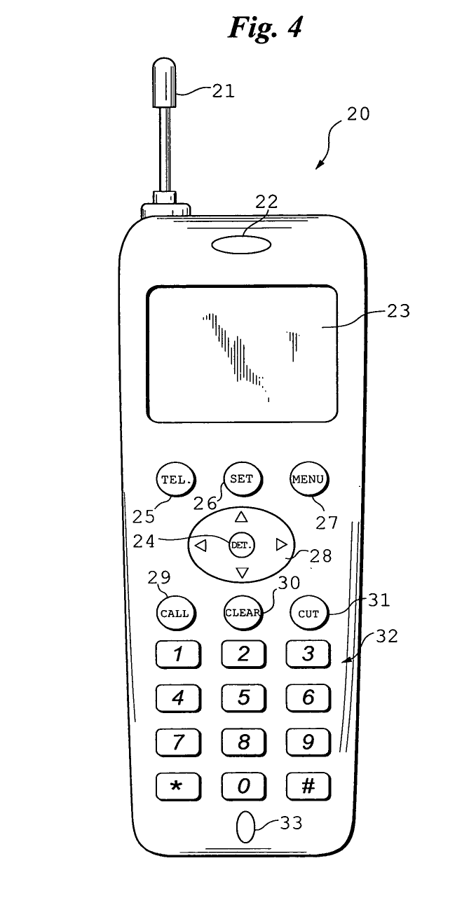

FIG. 4 illustrates the appearance of the camera phone 20 as viewed from its front surface. Since a digital camera is provided on a rear surface of the camera phone 20, it is not illustrated in FIG. 4.

An antenna 21 for establishing data communication (making telephone calls) with another cellular phone, the printer 60, a server, and so on via a network is formed on the top of the camera phone 20.

A speaker 22 for outputting audio is provided in an upper part on a front surface of the camera phone 20.

A liquid crystal display screen 23 is formed below the speaker 22. An input image represented by the input image data transmitted from the printer 60, the remaining capacity of a battery in the camera phone 20, the receiving state of a radio wave of the camera phone 20, and the like are displayed on the liquid crystal display screen 23.

A telephone directory button 25 that is pressed by a user when stored telephone numbers are displayed as a list on the liquid crystal display screen 23, a set button 26 that is pressed by the user when a set command is given, and a menu button 27 that is pressed by the user when a menu is displayed on the liquid crystal display screen 23 are provided below the liquid crystal display screen 23.

An up/down and right/left button 28 is arranged below the buttons 25, 26, and 27. An up-arrow, a down-arrow, a left-arrow, and a right-arrow are formed on the up/down and right/left button 28. The arrows can be pressed. By pressing the arrow, a signal indicating which of the arrows has been pressed is inputted. Further, the center of the up/down and right/left button 28 can be also pressed. A determination command is inputted by the press of the center (a determination button 24).

A call button 29, a clear button 30, and a cut button 31 are formed below the up/down and right/left button 28. A ten-keypad 32 is formed below the buttons 29, 30, and 31.

A microphone 33 for inputting audio is formed in a lower part on the front surface of the camera phone 20.

Thus, in the camera phone 20, the determination button 24, the set button 26, the menu button 27, the up/down and right/left button 28, the clear button 30, and the ten-keypad 32 are provided as an input device for giving a command while seeing an input image.

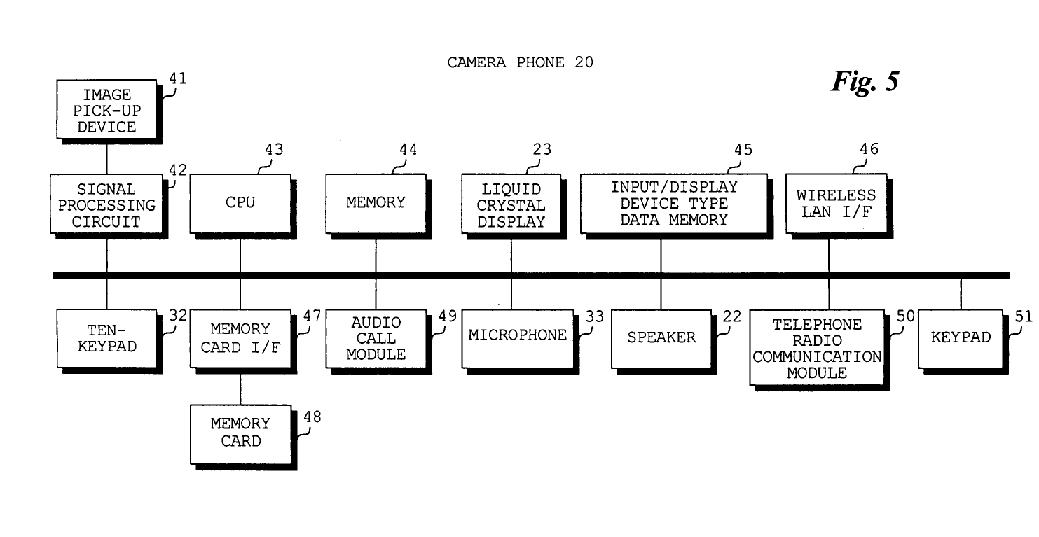

FIG. 5 is a block diagram showing the electrical configuration of the camera phone 20.

The overall operation of the camera phone 20 is supervised by a CPU 43.

In the camera phone 20, data representing the type of the input device and the type of the display device are also transmitted to the printer 60 from the camera phone 20, as described above. Therefore, the camera phone 20 comprises an input/display device type data memory 45 for storing type data.

The camera phone 20 comprises a keypad 51 such as the telephone directory button 25 and the set button 26 in addition to the ten-keypad 32, as described above. Various types of signals outputted from the ten-keypad 32 are inputted to the CPU 43.

When the menu button 27 is pressed, a menu image is displayed on the liquid crystal display screen 23. Various types of modes are settable utilizing the menu image.

When a telephone call mode is set, audio inputted from the microphone 33 is converted into an analog audio signal, and the analog audio signal is fed to an audio call module 49. In the audio call module 49, predetermined audio call processing such as conversion from the analog audio signal into digital audio data is performed. The audio data outputted from the audio call module 49 is transmitted to another cellular phone or the like via a wireless LAN interface 46.

The digital audio data transmitted from another cellular phone is inputted to the camera phone 20 via the wireless LAN interface 46. The digital audio data is converted into an analog audio signal in the audio call module 49, and is fed to the speaker 22. The audio is outputted from the speaker 22.

When an image pick-up mode is set, a subject is sensed by an image pick-up device 41 such as a CCD, and a video signal representing the subject image is inputted to a signal processing circuit 42. In the signal processing circuit 42, predetermined signal processing such as while balance adjustment analog-to-digital conversion processing or the like is performed, so that digital image data representing the subject image is outputted. The digital image data is fed to the liquid crystal display device 23 (the liquid crystal display device is also assigned the same character as the liquid crystal display screen 23). The subject image is displayed on the liquid crystal display screen 23.

When the determination button 24 is pressed (the determination button 24 functions as a shutter release button in the image pick-up mode), digital image data obtained by the sensing is fed to a memory 44 and is temporarily stored therein. The digital image data is read out of the memory 44, and is fed to a memory card 48 via a memory card interface 47 and is recorded thereon. It goes without saying that the image data is subjected to data compression processing, as required, and the data-compressed image data is recorded in the memory card 48.

When a print mode is set, the type data stored in the input/display device type data memory 45 is read, and is subjected to required communication processing such as data compression in a telephone radio communication module 50. The type data outputted from the telephone radio communication module 50 is transmitted to the printer 60 from the wireless LAN interface 46. Consequently, input image data suitable for the input device in the camera phone 20 is transmitted to the camera phone 20 from the printer 60. An input image suited to be given a command from the input device is displayed on the display device 23 of the camera phone 20.

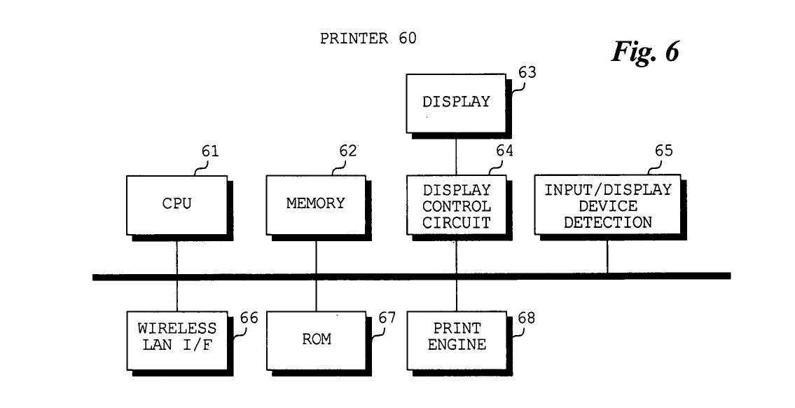

FIG. 6 is a block diagram showing the electrical configuration of the printer 60.

The overall operation of the printer 60 is supervised by a CPU 61.

The printer 60 comprises an input/display device detection circuit 65 for detecting from the type data transmitted from the portable electronic device such as the digital still camera 1 or the camera phone 20 the input device and the display device in the portable electronic device. The image data for generating input images suitable for the detected input device and display device are previously stored in a ROM 67 for each of the input device and the display device.

The printer 60 comprises a wireless LAN interface 66 for receiving the type data or the like transmitted from the portable electronic device such as the digital still camera 1 or the camera phone 20 and transmitting the input image data or the like. Further, the printer 60 comprises a liquid crystal display device 63 whose display is controlled by a display control circuit 64.

When image data is transmitted from the portable electronic device, the image data is received in the printer 60, and is temporarily stored in the memory 62. The image data is read out of the memory 62, and is fed to a print engine 68. An image represented by the received image data is printed by the print engine 68.

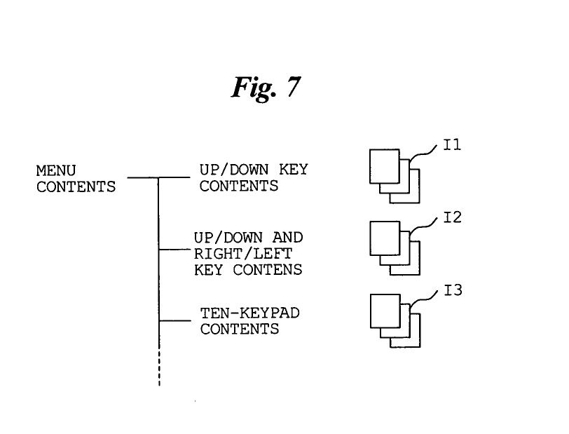

FIG. 7 illustrates an example of menu contents (image data for generating an input image) stored in the ROM 67 in the printer 60.

As described in the foregoing, the ROM 67 in the printer 60 previously stores menu contents suitable for each input device, for example, menu contents I1 in a case where there is an up/down key (button) in the input device included in the portable electronic device that communicates with the printer 60 (hereinafter referred to as a up/down key menu contents I1), menu contents I2 in a case where there is an up/down and right/left key in the input device (hereinafter referred to as an up/down and right/left key menu contents I2), and menu contents I3 in a case where there is a ten-keypad in the input device (hereinafter referred to as a ten-keypad menu contents I3).

For example, the up/down key menu contents I1 are selected when the input device in the portable electronic device that communicates with the printer 60 includes the up/down key, the up/down and right/left key menu contents I2 are selected when the input device includes the up/down and right/left key, and the ten-keypad menu contents I3 are selected when the input device includes the ten-keypad. In the case of a portable electronic device having an input device including both a ten-keypad and an up/down and right/left button, it goes without saying that priorities are previously determined such that any of the menu contents (e.g., the ten-keypad menu contents I3) are selected.

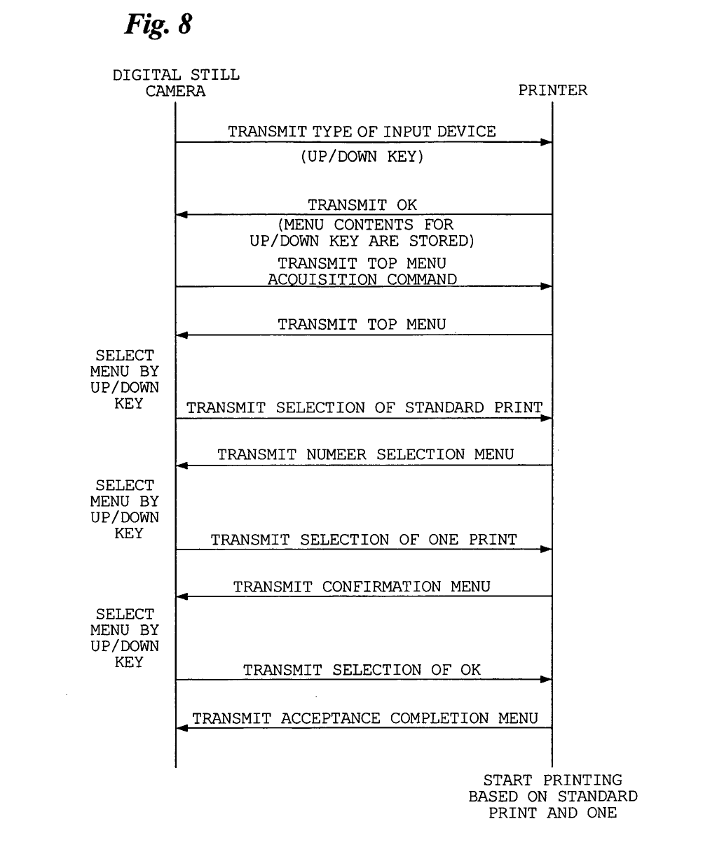

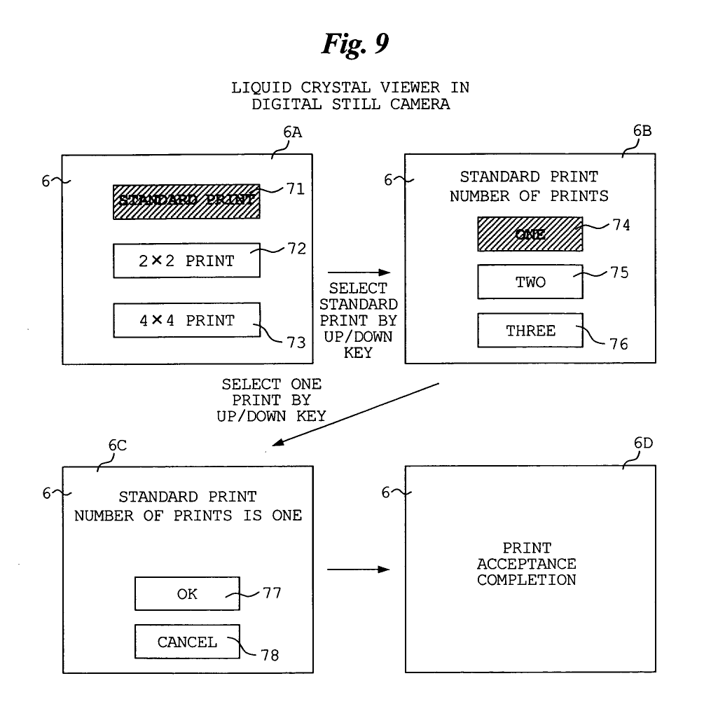

FIG. 8 is a flow chart showing the procedure for communication processing between the digital still camera 1 and the printer 60. FIG. 9 shows how a menu image displayed on the liquid crystal viewer 6 in the digital still camera 1 is changed.

The digital still camera 1 does not include a ten-keypad, and includes the up/down button 7. Therefore, menu contents suitable for a portable electronic device including an input device having an up/down button are transmitted to the digital still camera 1 from the printer 60.

When the digital still camera 1 is set to a communication mode, the type data representing the type of the input device (having an up/down key) is transmitted to the printer 60 from the digital still camera 1.

When the type data transmitted from the digital still camera 1 is received in the printer 60, processing for detecting what type of input device is included as the input device in the digital still camera 1 from the type data is performed. By this processing, it is detected in the printer 60 that the digital still camera 1 includes the up/down key as the input device. Consequently, it is confirmed whether or not the ROM 67 in the printer 60 stores menu contents suitable for the up/down key. When the menu contents are stored, OK data indicating that the menu contents suitable for the up/down key are stored in the printer 60 is transmitted to the digital still camera 1 from the printer 60. When the menu contents are not stored, NG data indicating that the menu contents suitable for the up/down key are not stored in the printer 60 is transmitted to the digital still camera 1 from the printer 60.

When the OK data is transmitted from the printer 60, and the transmitted OK data is received in the digital still camera 1, a top menu acquisition command is transmitted to the printer 60 from the digital still camera 1.

When the top menu acquisition command is received in the printer 60, top menu contents are read out of the up/down key menu contents I1. The read top menu contents are transmitted to the digital still camera 1 from the printer 60.

Referring to FIG. 9, when the top menu contents transmitted from the printer 60 are received in the digital still camera 1, a top menu image 6A is displayed on the liquid crystal viewer 6 in the digital still camera 1.

The top menu image 6A includes a standard print area 71, a 2×2 print area 72, and a 4×4 print area 73. The areas 71, 72, and 73 are arranged in line in the longitudinal direction. The standard print area 71 is selected when an image is printed on print paper of standard size. The 2×2 print area 72 is selected when an image is printed on print paper of 2×2 size. The 4×4 print area 73 is selected when an image is printed on print paper of 4×4 size. The color of the area is changed from the colors of the other areas (indicated by hatching) so as to show how any one of the areas 71, 72, and 73 is selected, and is changed such that the area above the area whose color is changed (the lowermost area in a case where the color of the uppermost area is changed) is selected in response to the press of the up-arrow in the up/down button 7. Similarly, the color of the area is changed such that the area below the area whose color is changed (the uppermost area in a case where the color of the lowermost area is changed) is selected in response to the press of the down-arrow in the up/down button 7. When the OK button 9 is pressed, the size specified by the selected area is determined. Since the areas 71, 72, and 73 constituting the top menu image 6A are arranged in line in the longitudinal direction, selection using the up/down button 7 becomes relatively easy.

Returning to FIG. 8, when the standard print is selected, and the OK button 9 is pressed, data indicating that the standard print is selected is transmitted to the printer 60 from the digital still camera 1.

When the data, indicating that the standard print is selected, transmitted from the digital still camera 1 is received in the printer 60, the selection of the standard print is stored in the printer 60. Further, number selection menu contents are read out of the up/down key menu contents I1 from the ROM 67 in the printer 60. The read number selection menu contents are transmitted to the digital still camera 1 from the printer 60.

When the number selection menu contents transmitted from the printer 60 are received in the digital still camera 1, a number selection menu image 6B is displayed on the liquid crystal viewer 6 in the digital still camera 1, as shown in FIG. 9.

On the number selection menu image 6B, a one-print area 74, a two-print area 75, and a three-print area 76 are arranged in line in the longitudinal direction. On the selection menu image 6B, the selected area is also indicated by hatching. The one-print area 74 is an area selected when one print is made from an image. The two-print area 75 is an area selected when two prints are made from an image. The three-print area 76 is an area selected when three prints are made from an image. Similarly to the top menu, the area 74, 75, or 76 is selected in response to the press of the up/down button 7. When the OK button 9 is pressed, data indicating the number of prints specified by the area selected when the button is pressed is transmitted to the printer 60 from the digital still camera 1.

Returning to FIG. 8, when the one print is selected, and the OK button 9 is pressed, data indicating that the number of prints is one is transmitted to the printer 60 from the digital still camera 1.

When the data, indicating that the number of prints is one, transmitted from the digital still camera 1 is received in the printer 60, the selected number of prints (one) is stored in the printer 60. Further, confirmation menu contents are read out of the up/down key menu contents I1, and are transmitted to the digital still camera 1 from the printer 60.

When the confirmation menu contents transmitted from the printer 60 are received in the digital still camera 1, a confirmation menu image 6C is displayed on the liquid crystal viewer 6 in the digital still camera 1, as shown in FIG. 9.

The confirmation menu image 6C includes print contents designated by the user (the print is a standard print, and the number of prints is one), and an OK area 77 and a cancel area 78. The OK, area 77 and the cancel area 78 are arranged in the vertical direction. When the OK button 9 is pressed, data indicating that the OK button 9 is pressed is transmitted to the printer 60 from the digital still camera 1. When the cancel button 10 is pressed, data indicating that the cancel button 10 is pressed is transmitted to the printer 60 from the digital still camera 1.

Returning to FIG. 8, when the OK button 9 is pressed, the OK data indicating that the OK button 9 is pressed is transmitted to the printer 60 from the digital still camera 1, as described above.

When the OK data transmitted from the digital still camera 1 is received in the printer 60, acceptance completion menu contents are found out of the up/down key menu contents I1. The found acceptance completion menu contents are transmitted to the digital still camera 1 from the printer 60.

When the acceptance completion menu contents are received in the digital still camera 1, a print acceptance completion menu 6D is displayed on the liquid crystal viewer 6 in the digital still camera 1, as shown in FIG. 9.

In the printer 60, the printing of an image is started on the basis of the print contents (the print is a standard print, and the number of prints is one) set by the user of the digital still camera 1. It goes without saying that an image to be printed is previously selected by the user of the digital still camera 1, and image data representing the image is transmitted to the printer 60.

Although in the above-mentioned embodiment, the printer 60 and the digital still camera 1 having the up/down button 7 provided therein communicate with each other, the printer 60 and the camera phone 20 can also communicate with each other, as described above.

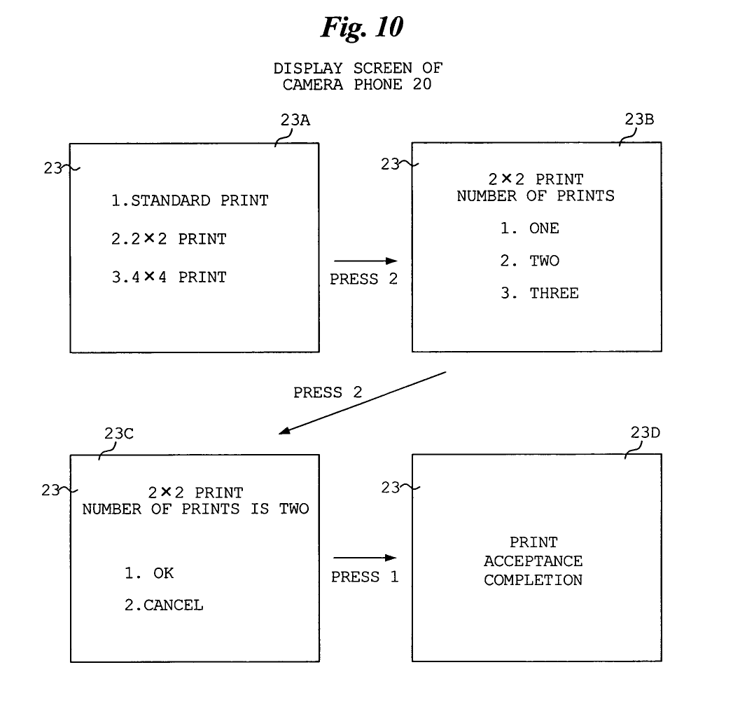

FIG. 10 shows how menu contents displayed on the display screen 23 of the camera phone 20 that communicates with the printer 60 are changed.

Although the digital still camera 1 is provided with the up/down button 7 and is provided with no ten-keypad, as described above, the camera phone 20 is provided with a ten-keypad. Therefore, menu contents suitable for input utilizing the ten-keypad are displayed on the display screen 23 of the camera phone 20.

When data representing the type of the input device (the ten-keypad 32 is included in the input device) is transmitted from the camera phone 20 to the printer 60, as described above, it is confirmed whether or not the ten-keypad menu contents I3 are stored in the printer 60. Printing top menu contents are found out of the ten-keypad menu contents I3 in response to the fact that a printing menu acquisition command transmitted from the camera phone 20 is received in the printer 60. The found printing top menu contents are transmitted to the camera phone 20 from the printer 60. Consequently, a printing top menu 23A is displayed on the display screen 23 of the camera phone 20.

On the printing top menu 23A, characters “standard print”, “2×2 print”, and “4×4 print” that respectively designate the print size are displayed in correspondence with Arabic numerals 1, 2, and 3. When the “standard print”is designated, a keypad “1” in the ten-keypad 32 in the camera phone 20 is pressed. Similarly, a keypad “2” is pressed when the “2×2 print” is designated, and a keypad “3” is pressed when the “4×4 print” is designated. Data representing the pressed keypad is transmitted to the printer 60 from the camera phone 20.

When the keypad “2” is pressed, the “2×2 print” is selected as the print size, and data representing the “2×2 print” is transmitted to the digital still camera 1 from the camera phone 20. Consequently, number selection menu contents are found out of the ten-keypad menu contents I3, and are transmitted to the camera phone 20 from the printer 60. Consequently, a number selection menu 23B is displayed on the display screen 23 of the camera phone 20.

On the number selection menu 23B, characters “one”, “two”, and “three” that respectively designate the numbers of prints are displayed in correspondence with Arabic numerals 1, 2, and 3. A keypad “1” is pressed when “one” is designated as the number of prints, a keypad “2” is pressed when “two” is designated, and a keypad “3” is pressed when “three” is designated.

When the keypad “2” is pressed, “two” is selected as the number of prints, so that data representing the number is transmitted to the digital still camera 1 from the camera phone 20. Consequently, confirmation menu contents are found out of the ten-keypad menu contents I3, and are transmitted to the camera phone 20 from the printer 60. Consequently, a confirmation menu 23C is displayed on the display screen 23 of the camera phone 20.

The confirmation menu 23C includes print contents (the print is “2×2 print” , and the number of prints is two) designated by the user and includes characters “OK” and characters “Cancel” in correspondence with Arabic numerals 1 and 2. In the same manner as described above, when a keypad “1” is pressed, data indicating that an OK command is accepted is transmitted to the printer 60 from the camera phone 20. When a keypad “2” is pressed, data indicating that a cancel command is accepted is transmitted to the printer 60 from the camera phone 20.

When the OK data is transmitted to the printer 60 from the camera phone 20, acceptance completion menu contents are read out of the ten-keypad menu contents I3. The read acceptance completion menu contents are transmitted to the camera phone 20 from the printer 60. Consequently, an acceptance completion menu 23D is displayed on the display screen 23 of the camera phone 20. The user of the camera phone 20 finds that prints are accepted in the printer 60. Thereafter, in the printer 60, prints are made in accordance with an instruction from the user of the camera phone 20.

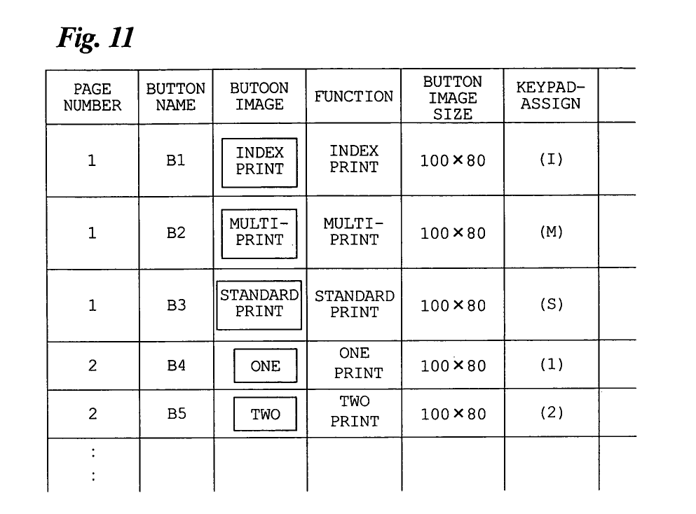

FIGS. 11 to 14 illustrate a modified example.

Although in the above-mentioned embodiment, the menu contents corresponding to the input device are stored in the printer 60, information for producing menu contents is stored in the printer 60 to produce menu contents corresponding to the input device in the following example.

FIG. 11 illustrates an example of a table indicating menu contents production information stored in the ROM 67 in the printer 60.

The menu contents production information includes a page number, a button name, a button image, a function, a button image size, a keypad-assign, etc.

The page number is for defining menu contents included in the same image. Contents having the same page number constitute one menu. The button name is for identifying the button image. The button image is an image representing an area displayed on the menu. The function is a function indicated by the button image. The size of the button image indicates the respective sizes in the longitudinal direction and the transverse direction of the button image. The keypad-assign indicates a keypad code assigned when the function indicated by the button image is designated using a keypad.

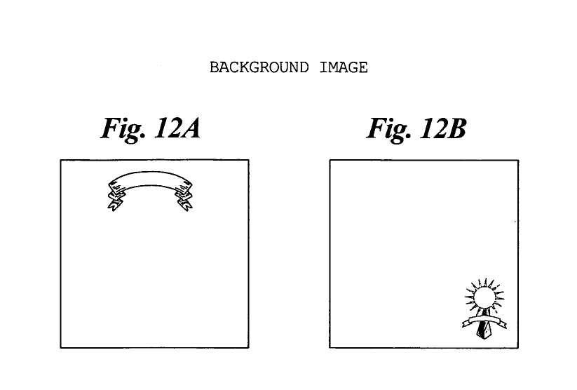

FIGS. 12A and 12B illustrate examples of background images of the menu.

Image data representing the background images of the menu are also stored in the ROM 67 in the printer 60. The background images are backgrounds of the menu. It is previously determined which of the background images is to be used for the menu.

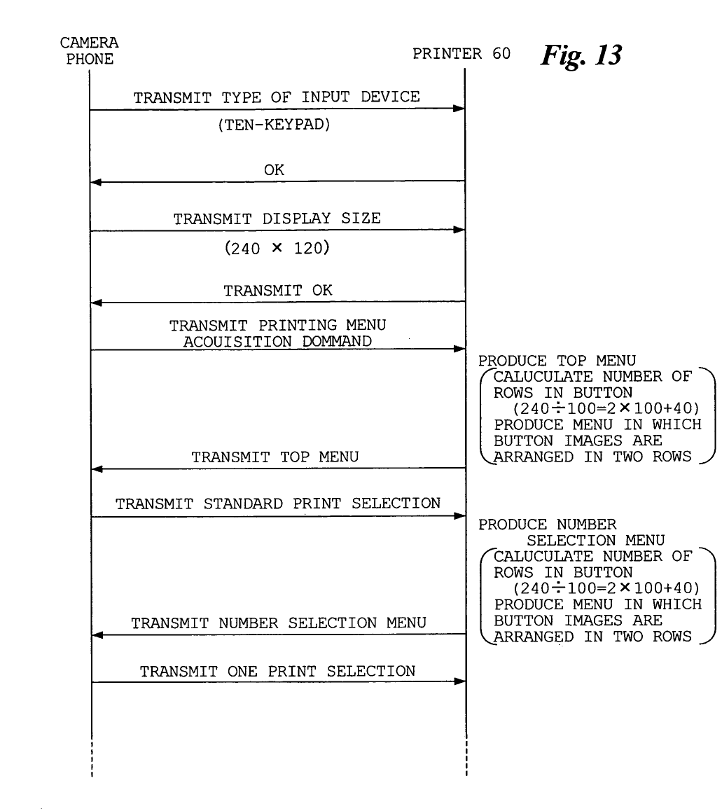

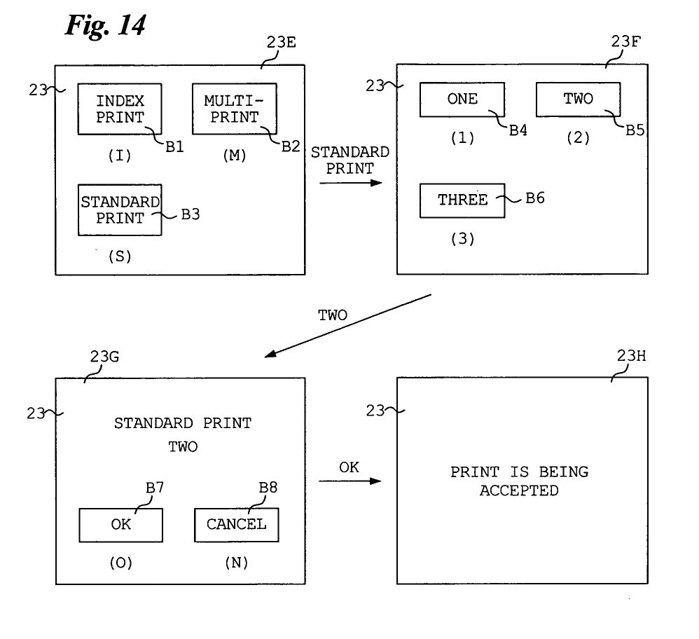

FIG. 13 is a flow chart showing the procedure for processing of the camera phone 20 and the printer 60 in a case where menu contents are produced in the printer 60. FIG. 14 illustrates examples of menu contents displayed on the display screen 23 of the camera phone 20.

Type data representing the type of an input device (a ten-keypad) in the camera phone 20 is transmitted to the printer 60 from the camera phone 20. When the type data is received in the printer 60, OK data indicating that the type data is received is transmitted to the camera phone 20 from the printer 60.

When the OK data transmitted from the printer 60 is received in the camera phone 20, display size data representing the display size (240 pixels in breadth by 120 pixels in length) of the camera phone 20 is transmitted to the printer 60 from the camera phone 20. When the display size data is received in the printer 60, OK data indicating that the display size data is received is transmitted to the camera phone 20 from the printer 60.

When the OK data is received in the camera phone 20, a printing menu acquisition command is transmitted to the printer 60 from the camera phone 20. When the printing menu acquisition command is received in the printer 60, a top menu is produced using the type of the input device in the camera phone 20, the display size, and the button image size. Specifically, the number of button images (the number of rows) that can be included in the transverse direction of the display size is first calculated. Since the number of pixels in the transverse direction of the display size is 240, and the number of pixels in the transverse direction of the button image is 100, the button images can be arranged in two rows on the display screen of the camera phone 20 (240 divided by 100 gives 2 with a remainder of 40). Top menu contents in which button images are arranged in two rows are produced. The produced top menu contents are transmitted to the camera phone 20 from the printer 60. Consequently, a top menu (top menu contents) 23E produced in the printer 60 is displayed, as shown in FIG. 14, on the display screen 23 of the camera phone 20.

The top menu 23E includes a button image B1 representing an index print function, a button image B2 representing a multi-print function, and a button image B3 representing a standard print function. The button image B1 and the button image B2 are arranged in two rows, and the button image B1 and the button image B3 are arranged in two columns. Keypad-assign characters (I), (M), and (S) assigned to the button images B1, B2, and B3 are respectively displayed below the button images. The characters (I), (M), and (S) are inputted utilizing the keypad 32 in the camera phone 20, so that respective commands to make an index print, a multi-print, and a standard print are fed to the camera phone 20.

When the keypad-assign character (S) is inputted utilizing the keypad 32 in the camera phone 20, data representing the selection of the standard print is transmitted to the printer 60 from the camera phone 20. Consequently, number selection menu contents are produced in the printer 60. The number selection menu contents are produced, similarly to the above-mentioned top menu contents. The produced number selection menu contents are transmitted to the camera phone 20 from the printer 60. When the number selection menu contents are received in the camera phone 20, a number selection menu 23F is displayed on the display screen, as shown in FIG. 14.

The number selection menu 23F includes a button image B4 indicating that one is designated as the number of prints, a button image B5 indicating that two is designated, and a button image B6 indicating that three is designated. The button image B4 and the button image B5 are arranged in two rows, and the button image B4 and the button image B6 are arranged in two columns. Keypad-assign characters (1), (2), and (3) assigned to the button images B4, B5, and B6 are respectively displayed below the button images. The characters (1), (2), and (3) are inputted utilizing the keypad 32 in the camera phone 20, so that respective commands to make one print, two prints, and three prints are fed to the camera phone 20.

When the keypad-assign character (2) is inputted utilizing the keypad 32 in the camera phone 20, data indicating that the number of prints is two is transmitted to the printer 60 from the camera phone 20. Consequently, confirmation menu contents are produced in the printer 60 in the same manner as described above. The produced confirmation menu contents are transmitted to the camera phone 20. Consequently, a confirmation menu 23G is displayed on the display screen 23 of the camera phone 20.

On the confirmation menu 23G, an OK button B7 and a cancel button B8 are displayed in two rows in addition to indication that the print size is of the standard print and the number of prints is two. Further, keypad-assign characters (O) and (N) are respectively displayed below the OK button B7 and the cancel button B8. The character (O) is inputted using the keypad 32, so that an OK command is given to the camera phone 20. The character (N) is inputted, so that a cancel command.is given to the camera phone 20. When the character (O) is inputted from the keypad 32, acceptance completion menu contents are produced in the printer 60 (acceptance menu contents may be previously produced because they do not include a button image), and the produced acceptance menu contents are transmitted to the camera phone 20 from the printer 60. An acceptance completion menu 23H is displayed on the display screen 23 of the camera phone 20.

Although in the above-mentioned embodiment, description was made of a case where menu contents are produced in the printer 60 when the camera phone 20 and the printer 60 communicate with each other, not the camera phone 20 but another electronic device such as a digital still camera can produce menu contents depending on an input device and a display device provided in the electronic device.

Although the present invention has been described and illustrated in detail, it is clearly understood that the same is by way of illustration and example only and is not to be taken by way of limitation, the spirit and scope of the present invention being limited only by the terms of the appended claims.

1. An image data communication system comprising a portable electronic device and an image server that can communicate with each other, wherein
said portable electronic device comprises
a display device displaying an input image represented by input image data transmitted from the image server,
an input device inputting a command to the portable electronic device on the basis of the input image displayed on a display screen of said display device, and
a type data transmission device transmitting to the image server type data representing the type of said input device,
said image server comprises
a detection device detecting the input image suitable for display on the display screen of said display device in said portable electronic device on the basis of the type data transmitted from said type data transmission device in said portable electronic device, and
an input image data transmission device transmitting to said portable electronic device the input image data representing the input image detected by said detection device.

2. The image data communication system according to claim 1, further comprising
an input image data generation device generating the input image data representing the input image detected by said detection device,
wherein said input image data transmission device transmitting to said portable electronic device the input image data generated by said input image data generation device.

3. The image data communication system according to claim 1, wherein
said image server further comprises
an input image data storage device storing input image data representing a plurality of input images corresponding to the type of the input device in the portable electronic device, and
a retrieval device finding, out of the input image data stored in said input image data storage device, the input image data corresponding to the input image detected by said detection device,
said input image data transmission device transmits to said portable electronic device the input image data found by said retrieval device.

4. A portable electronic device comprising:
a display device displaying an input image represented by input image data transmitted from an image server;
an input device inputting a command to the portable electronic device on the basis of the input image displayed on a display screen of the display device; and
type data transmission device transmiting to the image server type data representing the type of the input device.

5. An image server comprising:
a detection device detecting, on the basis of type data, transmitted from a portable electronic device, representing the type of an input device in the portable electronic device, an input image suitable for display on a display screen of a display device in the portable electronic device; and
an input image data transmission device transmitting to the portable electronic device input image data representing the input image detected by the detection device.

6. In a portable electronic device comprising a display device that displays an input image and an input device that gives a command to the portable electronic device on the basis of the input image displayed on a display screen of the display device,
a method of controlling the portable electronic device, comprising the steps of:
transmitting to an image server type data representing the type of the input device;
receiving input image data, transmitted from the image server in response to the transmission of the type data, representing an input image suitable for the input device; and
displaying on the display screen the input image represented by the received input image data.

7. A method of controlling an image server, comprising the steps of:
detecting, on the basis of type data, transmitted from a portable electronic device, representing the type of an input device in the portable electronic device, an input image suitable for display on a display screen of a display device in the portable electronic device; and
transmitting to the portable electronic device input image data representing the detected input image.
